(19) United States
(12) Patent Application Publication
(10) Pub. No.: US 2024/0409163 A1
(43) Pub. Date: Dec. 12, 2024

(54) VEHICLE BOTTOM STRUCTURE

(71) Applicant: Honda Motor Co., Ltd., Tokyo (JP)

(72) Inventors: Yasunori WATANABE, Saitama (JP); Masayasu YOSHIDA, Saitama (JP)

(73) Assignee: Honda Motor Co., Ltd., Tokyo (JP)

(21) Appl. No.: 18/631,071

(22) Filed: Apr. 10, 2024

(30) Foreign Application Priority Data
Jun. 7, 2023 (CN) 202310667582.8

(51) Int. Cl. B62D 25/20; B62D 25/24

(52) U.S. Cl. CPC B62D 25/20; B62D 25/24

(57) ABSTRACT

A vehicle bottom structure includes a floor panel, and an undercover that covers a lower side of the floor panel in a vehicle up-down direction. The undercover includes a bottom plate and a reinforcement member. The bottom plate is disposed on an outer side in the vehicle bottom structure. The reinforcement member is disposed at a position between the bottom plate and the floor panel in the vehicle up-down direction and close to a central side of the bottom plate in a vehicle width direction, and the reinforcement member extends along a vehicle front-rear direction.

### CROSS-REFERENCE TO RELATED APPLICATION

This application claims the priority benefit of China application serial no. 202310667582.8, filed on Jun. 7, 2023. The entirety of the above-mentioned patent application is hereby incorporated by reference herein and made a part of this specification.

### BACKGROUND

### Technical Field

The disclosure relates to a vehicle bottom structure.

### Related Art

To allow vulnerable groups such as the elderly, the disabled, and children to also use a sustainable transportation system, efforts have been made to provide a transportation tool with an improved vehicle body rigidity. In the art, a vehicle bottom structure includes a cover member that covers power components such as a motor and a transmission shaft, and the cover member has high rigidity and torsion resistance. However, the space between the cover member and the vehicle body is not effectively utilized, making it difficult for the overall structure to absorb impacts. Thus, there is a need to provide a sustainable transportation system by improving the rigidity of the vehicle body.

### SUMMARY

A vehicle bottom structure according to an embodiment of the disclosure includes a floor panel, and an undercover that covers a lower side of the floor panel in a vehicle up-down direction. The undercover includes a bottom plate and a reinforcement member. The bottom plate is disposed on an outer side in the vehicle bottom structure. The reinforcement member is disposed at a position between the bottom plate and the floor panel in the vehicle up-down direction and close to a central side of the bottom plate in a vehicle width direction, and the reinforcement member extends along a vehicle front-rear direction.

### BRIEF DESCRIPTION OF DRAWINGS

FIG. 1 is a schematic perspective view of a vehicle bottom structure according to an embodiment of the disclosure.

FIG. 2 is a partial schematic view of an undercover of the vehicle bottom structure in FIG. 1.

### DESCRIPTION OF EMBODIMENTS

Embodiments of the disclosure provide a vehicle bottom structure with an improved impact absorption efficiency and a lightweight structure.

A vehicle bottom structure according to an embodiment of the disclosure includes a floor panel, and an undercover that covers a lower side of the floor panel in a vehicle up-down direction. The undercover includes a bottom plate and a reinforcement member. The bottom plate is disposed on an outer side in the vehicle bottom structure. The reinforcement member is disposed at a position between the bottom plate and the floor panel in the vehicle up-down direction and close to a central side of the bottom plate in a vehicle width direction, and the reinforcement member extends along a vehicle front-rear direction.

In an embodiment of the disclosure, the vehicle bottom structure further includes a drive device and a transmission shaft. The drive device and the transmission shaft are disposed inside the undercover and close to an inner side in the vehicle front-rear direction. The undercover further includes a drive device contact part and a transmission shaft contact part. The drive device contact part and the transmission shaft contact part are disposed at positions close to the drive device and the transmission shaft, and an interior of the undercover is formed into a recessed shape corresponding to the drive device and the transmission shaft.

In an embodiment of the disclosure, the undercover further includes a drive device cover part that covers a lower part of the drive device in the vehicle up-down direction, and the drive device cover part extends along the vehicle front-rear direction.

In an embodiment of the disclosure, the undercover is a honeycomb structure.

Based on the above, in the vehicle bottom structure of the disclosure, the space between the vehicle body (floor panel) and the undercover is effectively utilized to dispose the reinforcement member, thereby improving the impact absorption efficiency against impacts from the rear side. While the impact absorption efficiency is improved, the quantity of surrounding frame components can also be reduced and the weight of materials thereof can be reduced, thereby achieving cost reduction. In addition, due to an increase in overall rigidity, bending or deformation of the undercover can be suppressed, and aerodynamics of the vehicle bottom can also be optimized. Moreover, since the weight of the undercover is increased, vibration of the vehicle body (floor panel) can be suppressed. Thus, the vehicle bottom structure of the disclosure exhibits an improved impact absorption efficiency and has a lightweight structure.

To make the above and other aspects of the disclosure more readily understandable, embodiments will be provided below and described in detail with reference to the accompanying drawings.

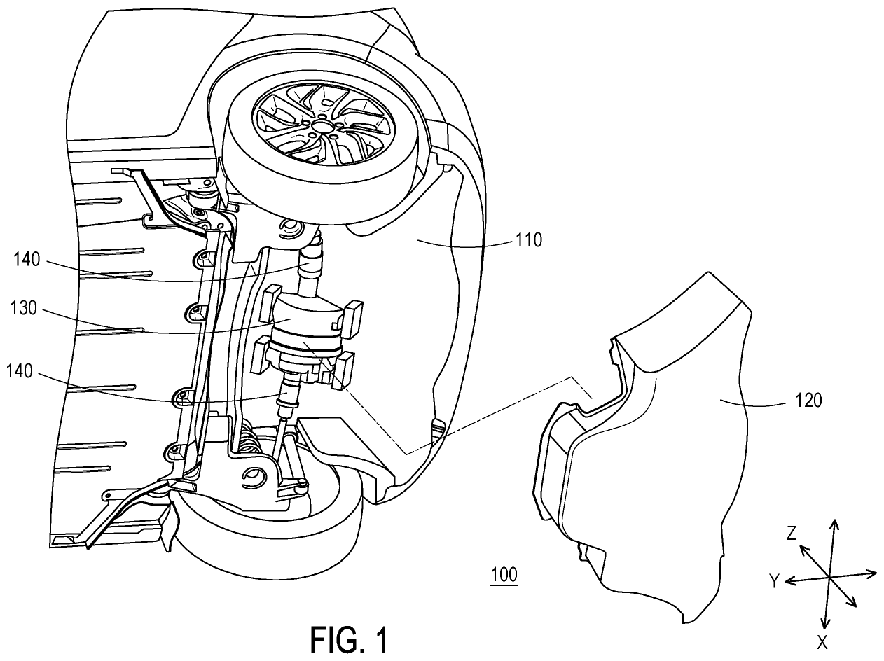

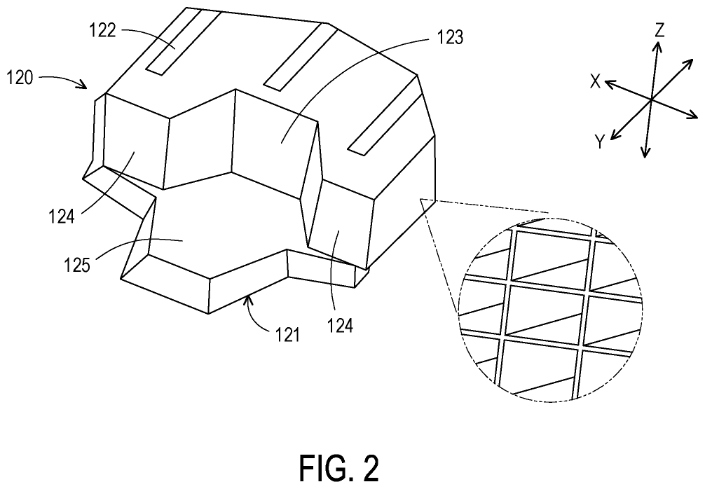

FIG. 1 is a schematic perspective view of a vehicle bottom structure according to an embodiment of the disclosure. FIG. 2 is a partial schematic view of an undercover of the vehicle bottom structure in FIG. 1. In this embodiment, a vehicle bottom structure 100 is, for example, a portion applied to a rear part of a vehicle chassis, and particularly, is configured to cover structures such as a drive device disposed at a vehicle bottom, but the disclosure is not limited thereto. A vehicle width direction X, a vehicle front-rear direction Y, and a vehicle up-down direction Z in the drawings do not limit the positional relationship of the components in the disclosure. Wherever possible, the same reference signs are used in the drawings and description to represent the same or similar parts. Hereinafter, the vehicle bottom structure 100 of this embodiment will be described with reference to FIG. 1 and FIG. 2.

Referring to FIG. 1 and FIG. 2, in this embodiment, the vehicle bottom structure 100 includes a floor panel 110, and an undercover 120 that covers a lower side of the floor panel 110 in the vehicle up-down direction Z. The undercover 120 is, for example, disposed at a rear part of a vehicle body in the vehicle front-rear direction Y, but may also be disposed at a front part of the vehicle body in the vehicle front-rear direction Y, which may be adjusted as needed and is not particularly limited in the disclosure. As shown in FIG. 2, the undercover 120 is, for example, a quadrangular honeycomb structure, thereby improving an impact absorption efficiency. In other unillustrated examples, the undercover 120 may also be pentagonal, hexagonal, or in another suitable shape, as long as the undercover 120 is capable of improving the impact absorption efficiency and has a deformation form that can be easily controlled to increase a design freedom.

Furthermore, the undercover 120 includes a bottom plate 121 and a reinforcement member 122. The bottom plate 121 is disposed on an outer side in the vehicle bottom structure 100. Specifically, the bottom plate 121 is disposed on a lower side of the floor panel 110 in the vehicle up-down direction Z. Thus, when viewing the vehicle body from the lower side to the upper side in the vehicle up-down direction Z, the bottom plate 121 is seen and is not shielded by other components. The reinforcement member 122 is disposed at a position between the bottom plate 121 and the floor panel 110 in the vehicle up-down direction Z and close to a central side of the bottom plate 121 in the vehicle width direction X. The reinforcement member 122 extends along the vehicle front-rear direction Y. The reinforcement member 122 is, for example, a bead, but may also be another component suitable for reinforcement, and the disclosure is not limited thereto.

Thus, in the vehicle bottom structure 100 of this embodiment, the space between the vehicle body (floor panel 110) and the undercover 120 is effectively utilized to dispose the reinforcement member 122, thereby improving the impact absorption efficiency against impacts from the rear side. While the impact absorption efficiency is improved, the quantity of surrounding frame components can also be reduced and the weight of materials thereof can be reduced, thereby achieving cost reduction. In addition, due to an increase in overall rigidity, bending or deformation of the undercover 120 can be suppressed, and aerodynamics of the vehicle bottom can also be optimized. Moreover, since the weight of the undercover 120 is increased, vibration of the vehicle body (floor panel 110) can be suppressed. Accordingly, the vehicle bottom structure 100 of this embodiment exhibits an improved impact absorption efficiency and has a lightweight structure.

In this embodiment, the vehicle bottom structure 100 further includes a drive device 130 and a transmission shaft 140. The drive device 130 and the transmission shaft 140 are disposed on a lower side of the floor panel 110 in the vehicle up-down direction Z. Specifically, the drive device 130 and the transmission shaft 140 are disposed inside the undercover 120 and close to the inner side in the vehicle front-rear direction Y (herein, the inner side is defined with respect to an outer edge of the vehicle body and refers to the front side in the vehicle front-rear direction Y in this embodiment). The undercover 120 is provided with a sidewall extending along the vehicle up-down direction Z at an outer edge of the bottom plate 121. Thus, the drive device 130 and the transmission shaft 140 are covered by the undercover 120 and are not seen from outside of the vehicle body.

Moreover, the undercover 120 further includes a drive device contact part 123 and a transmission shaft contact part 124. The drive device contact part 123 and the transmission shaft contact part 124 are disposed at positions close to the drive device 130 and the transmission shaft 140. Specifically, the drive device contact part 123 and the transmission shaft contact part 124 are opposite to the drive device 130 and the transmission shaft 140 in the vehicle front-rear direction Y, and the drive device contact part 123 and the transmission shaft contact part 124 are located on the rear side of the drive device 130 and the transmission shaft 140 in the vehicle front-rear direction Y. Further, the interior of the undercover 120 is formed into a recessed shape corresponding to the drive device 130 and the transmission shaft 140, that is, into a shape in which the drive device contact part 123 is recessed toward the rear side in the vehicle front-rear direction Y relative to the transmission shaft contact part 124. Accordingly, when an impact occurs, with the recessed design corresponding to the drive device 130 and the transmission shaft 140, the undercover 120 is capable of being more closely squeezed against the drive device 130 and the transmission shaft 140 and crushed, thereby exhibiting an improved impact absorption efficiency. Herein, the contact surfaces of the drive device contact part 123 and the transmission shaft contact part 124 are shown as planar, but in other unillustrated examples, they may also be in shapes that fit more closely to the drive device 130 and the transmission shaft 140, and the disclosure is not limited thereto.

In addition, in this embodiment, the undercover 120 further includes a drive device cover part 125 that covers a lower part of the drive device 130 in the vehicle up-down direction Z. The drive device cover part 125 extends along the vehicle front-rear direction Y to cover the entire drive device 130 without exposing the drive device 130 when viewed from the vehicle up-down direction Z. In this manner, the undercover 120 is capable of serving both impact absorption and component shielding functions.

In summary of the above, in the vehicle bottom structure of the disclosure, the space between the vehicle body (floor panel) and the undercover is effectively utilized to dispose the reinforcement member, thereby improving the impact absorption efficiency against impacts from the rear side. While the impact absorption efficiency is improved, the quantity of surrounding frame components can also be reduced and the weight of materials thereof can be reduced, thereby achieving cost reduction. In addition, due to an increase in overall rigidity, bending or deformation of the undercover can be suppressed, and aerodynamics of the vehicle bottom can also be optimized. Moreover, since the weight of the undercover is increased, vibration of the vehicle body (floor panel) can be suppressed. Furthermore, the undercover further includes the drive device contact part and the transmission shaft contact part. When an impact occurs, with the recessed design corresponding to the drive device and the transmission shaft, the undercover is capable of being more closely squeezed against the drive device and the transmission shaft and crushed, thereby exhibiting an improved impact absorption efficiency. Thus, the vehicle bottom structure of the disclosure exhibits an improved impact absorption efficiency and has a lightweight structure.

Finally, it should be noted that the above embodiments are only used to illustrate, rather than limit, the technical solutions of the disclosure. Although the disclosure has been detailed with reference to the aforementioned embodiments, those skilled in the art should understand that they may still modify the technical solutions recorded in the aforementioned embodiments, or equivalently replace some or all of the technical features; and these modifications or replacements do not depart from the essence of the corresponding technical solutions within the scope of the technical solutions of the embodiments of the disclosure.

What is claimed is:

1. A vehicle bottom structure comprising: a floor panel, and an undercover that covers a lower side of the floor panel in a vehicle up-down direction,
the undercover comprising:
a bottom plate disposed on an outer side in the vehicle bottom structure; and
a reinforcement member disposed at a position between the bottom plate and the floor panel in the vehicle up-down direction and close to a central side of the bottom plate in a vehicle width direction, wherein the reinforcement member extends along a vehicle front-rear direction.

2. The vehicle bottom structure according to claim 1, wherein
the vehicle bottom structure further comprises a drive device and a transmission shaft, and the drive device and the transmission shaft are disposed inside the undercover and close to an inner side in the vehicle front-rear direction, and
the undercover further comprises a drive device contact part and a transmission shaft contact part, the drive device contact part and the transmission shaft contact part are disposed at positions close to the drive device and the transmission shaft, and an interior of the undercover is formed into a recessed shape corresponding to the drive device and the transmission shaft.

3. The vehicle bottom structure according to claim 2, wherein
the undercover further comprises a drive device cover part that covers a lower part of the drive device in the vehicle up-down direction, and the drive device cover part extends along the vehicle front-rear direction.

4. The vehicle bottom structure according to claim 1, wherein
the undercover is a honeycomb structure.
